(19) United States
(12) Patent Application Publication
(10) Pub. No.: US 2011/0261462 A1
(43) Pub. Date: Oct. 27, 2011

(54) STRAY LIGHT OR SUN SHIELD FOR A CAMERA IN A MOTOR VEHICLE

(75) Inventors: Stefan Hahn, Ulm (DE); Ingo Dudeck, Weinstadt (DE); Juergen Seekircher, Ostfildern (DE)

(73) Assignee: DAIMLER AG, Stuttgart (DE)

(21) Appl. No.: 12/863,631

(22) PCT Filed: Jan. 21, 2009
(86) PCT No.: PCT/EP2009/000334

§ 371 Date: Jul. 20, 2010

(30) Foreign Application Priority Data
Mar. 3, 2008 (DE) 10 2008 012 203.3

(51) Int. Cl. G03B 11/00

(52) U.S. Cl. 359/601

(57) ABSTRACT

The invention relates to an anisotropic stray light or sun screen for a camera in a motor vehicle, wherein this sun screen shields the camera lens from stray light coming from the vehicle interior or is reflected by a window of the vehicle. The sun screen is thereby however designed in such a manner that a vehicle occupant can see the surroundings of the vehicle through the shield.

The invention relates to a stray light screen or filter or a sun screen for a camera in a motor vehicle according to the preamble of claim 1.

From the state of the art, for example DE 101 56 850 A1 or DE 103 29 900 A1 or JP 11-078737 A are known cameras, which are assembled in a motor vehicle and which are arranged in such a manner that they view the surroundings of this motor vehicle through a window (for example the windshield).

In order to avoid that reflected stray light is received by the camera in particular at the window and thus interferes with the image recording of the surroundings of the vehicle, it is suggested in JP 11-078737 A to provide a polarization filter in front of the lens of the camera in order to block this stray light. It is therein disadvantageous that this polarization filter also partially weakens the light from the surroundings and thus reduces the image quality.

It is however also conventional (DE 101 56 850 A1 or DE 103 29 900 A1) to introduce a screen between the camera or at least between the camera lens and the window, which blocks the access to the camera or the camera lens of the stray light coming from the interior of the vehicle and also the light reflected by the window. These screens however also prevent the view of the vehicle occupant to the surroundings of the vehicle in the region of the window section covered by them, which is particularly disadvantageous if the two lenses of a stereo camera are together shielded from stray light.

It is the object of the invention to create a stray light screen or sun screen for a camera in a motor vehicle which enables an optimum light entry from the surroundings of the vehicle into the camera and which does not restrict the viewing field of a vehicle occupant in an unnecessary manner.

The object is solved by a stray light screen or a sun screen for a camera with the characteristics of claim 1. Advantageous arrangements and further developments of the invention are described by the dependent claims.

With the stray light screen for a camera in a motor vehicle, the camera is directed to a window of the motor vehicle and detects the surroundings of the motor vehicle thereby. This window can be any window of the motor vehicle, however in particular its windshield or its rear window, for example with the use of a reversing (back-up) camera. A screen for minimizing the effect of stray light on the camera lens is arranged at least in the region between the camera or its camera lens and the window.

In accordance with the invention the screen herein has, at least in a partial region, a different (anisotropic) optical property depending on the direction. This anisotropic optical property is thereby arranged in such a manner that the camera lens is screened from light from the interior of the motor vehicle by the screen on the one hand, in particular from light that is reflected by the window in the direction of the camera lens, and that the screen is on the other hand transparent for light from the surroundings of the vehicle in such an optical manner that at least one occupant of the vehicle can visually perceive the surroundings of the vehicle through the screen.

In an advantageous manner, it is thus achieved by the invention that the at least one occupant of the vehicle can view the surroundings of the vehicle through the screen, and that his viewing field is thus not restricted by the screen.

In an advantageous arrangement of the invention, the different optical property of the partial region depending on the direction is realized by the integration of a semi-permeable mirror into the screen. It thus lends itself hereby in a particular manner to design the mirror surface in a manner that it reflects as little as possible, so that the at least one occupant of the vehicle is disturbed as little as possible by disturbing mirror effects. While the stray light coming from the interior is reflected at the semi-permeable mirror on the one hand, the occupant can view the surroundings of the vehicle through this semi-permeable mirror, which would otherwise be covered by the screen.

In an alternative arrangement of the invention, the direction-dependant different optical property of the partial region is realized by integrating an opening or disk provided with a polarization filter into the shield. The polarization filter is preferably designed in such a manner that the stray light reflected by the window is blocked by the shield, while the at least one occupant of the vehicle can view the surroundings of the vehicle through the polarization filter and thus the shield.

In a further alternative arrangement of the invention, the direction-dependant different optical property of the partial region of the screen is realized by introducing an anisotropic louver into the shield. In an analogous manner, it is also conceivable to realize the direction-dependant different optical property of the partial region of the screen by introducing channel-shaped apertures into the shield.

In order to enable the at least one occupant of the vehicle to have a view through the shield to the surroundings of the vehicle that is as uniform as possible, it is conceivable to arrange the openings of the anisotropic louver or the channel-shaped apertures with the same spacing and/or in a constant pattern.

In an advantageous manner, the channel-shaped apertures or the channels are guided through the partial region of the screen in such a manner that they are aligned in the direction of the eyes of the at least one occupant. The dimensions of the channel-shaped apertures or of the channels are designed in a beneficial manner so that different possible head positions, caused in particular by different height or posture of the at least one occupant of the vehicle are considered.

It is conceivable to arrange or align the individual channels or apertures in parallel to each other. It can however also be beneficial if the channels or apertures pass through the screen at different angles, in particular that they are preferably aligned to a common vanishing point, in an advantageous manner in the region of the eyes of the at least one occupant.

In a particularly advantageous arrangement of the invention, the channel-shaped apertures or the channels are realized by means of a lamellar structure. This is particularly beneficial, if this lamellar structure is arranged in an adjustable manner with regard to the angular alignment of the individual lamellae, so that it is possible for the at least one occupant of the vehicle to adjust or optimize the view through the screen to the surroundings of the vehicle in particular in view of his height or preferred seating position.

The invention is explained in the following in detail with the help of the figures. It shows thereby:

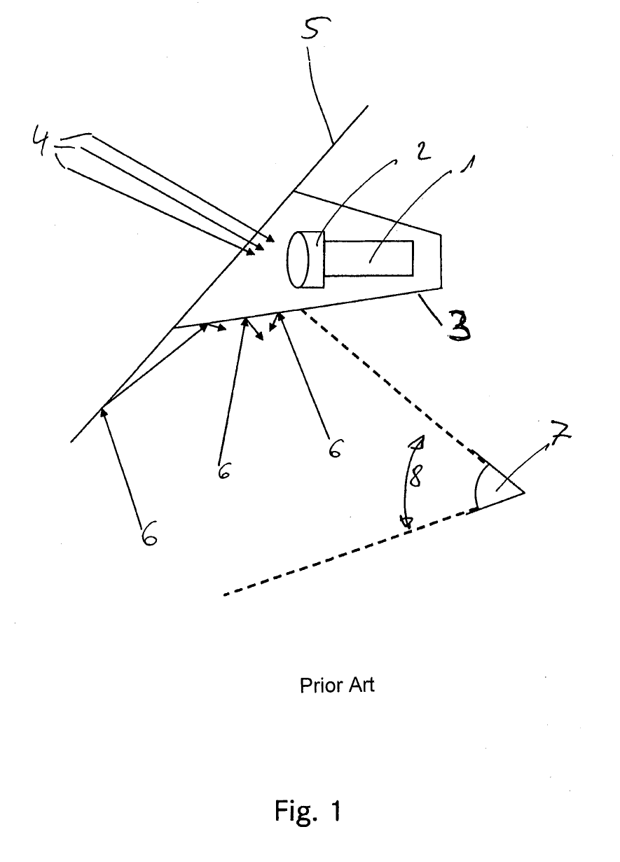

FIG. 1 a camera 1 with a camera lens 2 with an associated screen 3 as known from the state of the art;

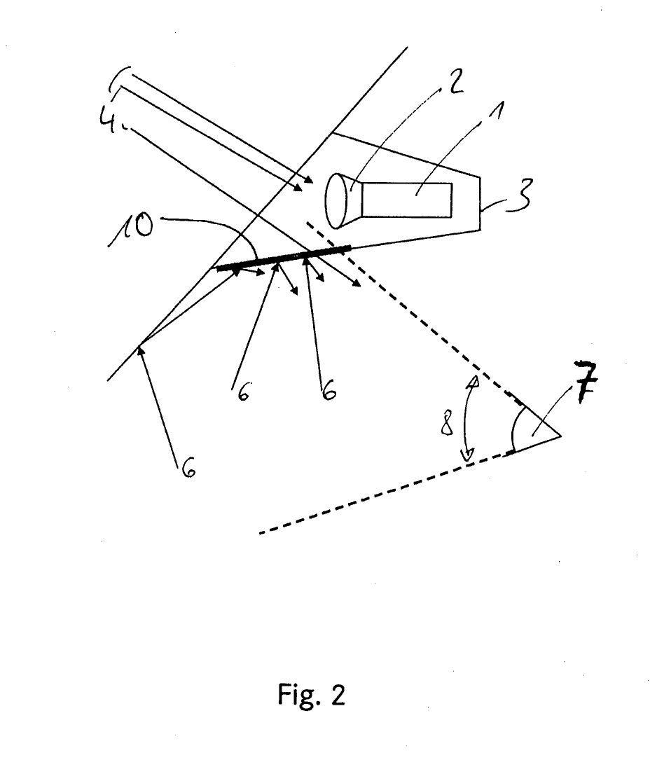

FIG. 2 a first arrangement of the invention, in which a partial region 10 of the screen 3 is formed as a semi-transparent region;

FIG. 3 an alternative arrangement of the invention, in which a partial region of the screen 3 is designed with an anisotropic louver or with channel-shaped apertures;

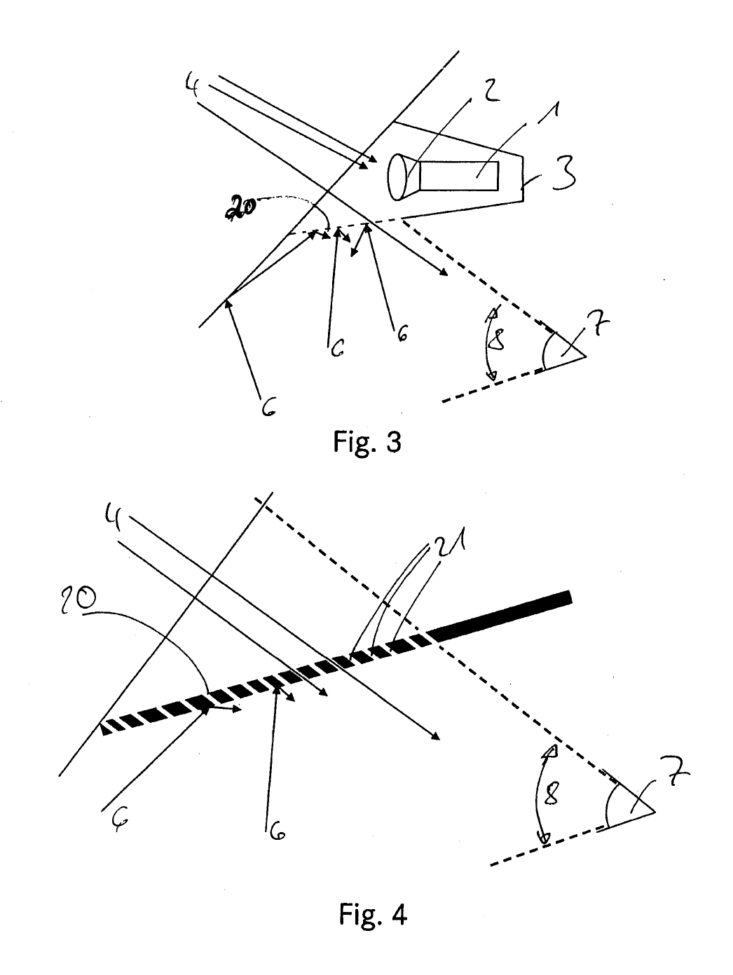

FIG. 4 a sectional enlargement of the arrangement from FIG. 3, which shows a parallel alignment of the channel-shaped apertures 21 in an exemplary manner;

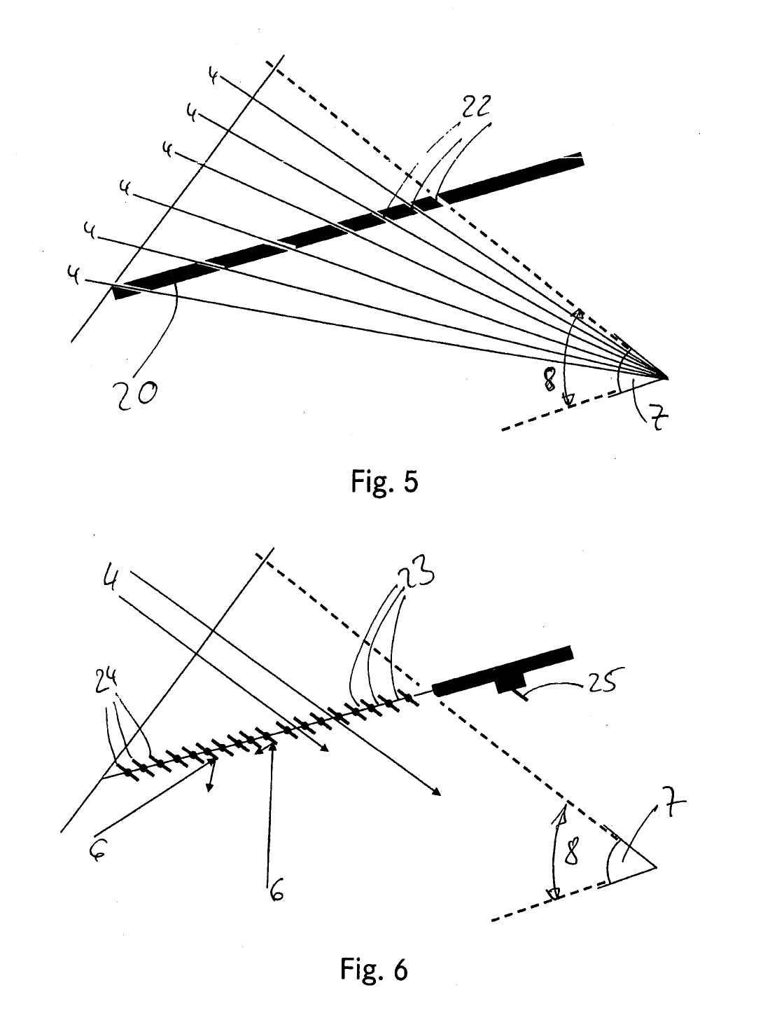

FIG. 5 a sectional enlargement of the arrangement from FIG. 3, which shows channel-shaped apertures 22 in an exemplary manner, which are aligned in such a manner that the light path through these intersect in the region of the eye 7 of the at least one occupant of the vehicle; and

FIG. 6 an alternative arrangement of the invention, in which the channel-shaped apertures 23 in a partial region of the shield are realized with the help of an adjustable lamellar structure.

FIG. 1 shows an arrangement of a camera 1 in a motor vehicle for viewing the surroundings through a window 5 known from the state of the art, for example DE 103 29 900 A1. The camera 1 and the associated camera lens 2 are enclosed by a screen 3, which prevents that stray light 6 radiates from a region in the interior of the vehicle into the camera lens 2. Light 4 from the surroundings of the vehicle can be detected through the window 5 by the camera 1 via its camera lens 2. The viewing region of the eye of an occupant of the vehicle is limited or restricted by the screen 3.

In the arrangement of the invention shown schematically in FIG. 2, a semi-transparent region 10 is formed in a partial region of the screen 3. This region 10 is not transparent for stray light 6 radiating from the interior of the vehicle to the screen 3, while however light coming from the surroundings of the vehicle can penetrate this, so that the occupant of the vehicle can view the surroundings of the vehicle through the partial region 10 of the shield. In a particularly advantageous manner, this semi-transparent region 10 is formed by the semi-transparent mirror, or this region 10 can analogously also be formed transparent and be provided with a polarization filter.

With the advantageous arrangement, as shown in FIG. 3, a partial region 20 of the screen 3 is provided with openings or channel-shaped apertures 21, so as to enable that light from the surroundings of the vehicle can pass through the screen 3 in this partial region 20, so that an eye 7 of a vehicle occupant can perceive the surroundings of the vehicle through the partial region 20 of the screen.

FIG. 4 shows an enlargement of the partial region 20 from FIG. 3. The channel-shaped apertures 21 are arranged in parallel with the example outlined here.

In the alternative arrangement of the invention shown in FIG. 5, the channel-shaped apertures 22 in the partial region 20 of the screen are arranged with a different angle to each other, preferably in such a manner that the radiation paths of the light 4 from the surroundings of the vehicle passing through them intersect in one point; this preferably in the region of the eye of the vehicle occupant.

In FIG. 6 is outlined an advantageous alternative arrangement of the invention, in which the passages 23 through the partial region 20 of the screen 3 are realized with the help of a lamellar structure. It is thereby provided that the angle position of the individual lamellae 24 can be adjusted in their angular alignment by means of an adjustment mechanism by actuating an adjustment lever 25. In this advantageous manner, the occupant of the vehicle can manually adapt or optimize his view through the partial region of the screen 3 provided with the lamellae 24 to his height or seat position.

The at least one occupant of the vehicle, who is provided a view to the surroundings of the vehicle through the screen 3 by the invention is preferably the driver of the vehicle.

1. A stray light screen for a camera in a motor vehicle, wherein the camera is oriented to a window of the motor vehicle and detects the surroundings of the motor vehicle through the window, and wherein a screen for minimizing the effect of stray light on the camera lens is arranged at least in the region between the camera lens and the window,
wherein the screen has a direction-dependant different (anisotropic) optical property at least in a partial region, in such a manner that the screen shields the camera lens from light from the interior of the motor vehicle, in particular from light that is reflected by the window towards the camera lens, and wherein the screen is optically transparent for light from the surroundings of the vehicle to the extent that at least one occupant of the motor vehicle can optically perceive the surroundings of the vehicle through the screen.

2. The stray light screen according to claim 1, wherein the direction-dependant different optical property of the partial region is realized by integrating a semi-transparent mirror into the screen.

3. The stray light screen according to claim 1, wherein the direction-dependant different optical property of the partial region is realized by integrating an opening or disk provided with a polarization filter into the screen.

4. The stray light screen according to claim 1, wherein the direction-dependant different optical property of the partial region is realized by introducing an anisotropic louver into the screen.

5. The stray light screen according to claim 1, wherein the direction-dependant different optical property of the partial region is realized by introducing channel-shaped apertures into the screen.

6. The stray light screen according to claim 4, wherein the openings in the louver or the channel-shaped apertures are arranged with the same distance or in a regular pattern with regard to each other.

7. The stray light screen according to claim 4, wherein the channels are aligned in the direction of the eye of the at least one occupant.

8. The stray light screen according to claim 7, wherein the channels are arranged in parallel to each other.

9. The stray light screen according to claim 7, wherein the channels are arranged with a different angle to each other.

10. The stray light screen according to claim 5, wherein the channel-shaped apertures are realized by means of a lamellar structure.

11. The stray light screen according to claim 10, wherein the lamellar structure or individual lamellae are designed to be adjustable manner in their alignment.
